(19) United States
(12) Patent Application Publication
(10) Pub. No.: US 2006/0141874 A1
(43) Pub. Date: Jun. 29, 2006

(54) Arrangement for welding ends of electrical conductor segment pairs of a rotating electrical machine winding

(76) Inventors: Romaric Lenoir, Neufchatel-Hardelot (FR); Pierre Faverolle, Montgeron (FR)

Correspondence Address: OSHA LIANG L.L.P., 1221 MCKINNEY STREET, SUITE 2800, HOUSTON, TX, 77010, US

(21) Appl. No.: 10/530,388

(22) PCT Filed: Oct. 7, 2003
(86) PCT No.: PCT/FR03/02936

§ 371 Date: Feb. 15, 2006

(30) Foreign Application Priority Data
Oct. 7, 2002 (FR) 0212442
Oct. 7, 2002 (FR) 0212441

(51) Int. Cl. H01R 4/02

(52) U.S. Cl. 439/874

(57) ABSTRACT

The invention concerns an arrangement for welding a rotating electrical machine winding consisting of a plurality of conductive segments supported on a supporting body (1) so that the ends of each pair of conductive segments to be welded are juxtaposed in a radial direction and arranged in radial rows (R) circumferentially offset relative to one another, said welding arrangement including an equipment for flanging the ends of the conductive segments to be welded, comprising circumferential locking means formed by cam-shaped portions (19) of flanging members (13, 13′), a cam portion (19) being configured so as to be urged to come into clamped position between the ends of two radial rows (R) by rotation of the flanging member. The invention is applicable to a motor vehicle alternator.

### BACKGROUND OF INVENTION

1. Scope of the Invention

The invention concerns an arrangement for welding the ends of electrically conducting segment pairs of the winding of a rotating electrical machine, such as the winding of a stator, which is formed by multiple conductive segments, the ends of which are connected in series by welding, and which are supported in a support body so that the pairs of conductive segment ends to be welded on an axial side of the support body form a chignon that is generally shaped like a ring, in which the ends of the conductive segment pairs to be welded are juxtaposed in a radial direction in relation to the support body, and are arranged on the outside of the support body in the form of radial rows that are offset circumferentially from each other; said welding arrangement includes a tool for flanging said ends during welding.

2. State of the Technology

Arrangements of this type are already known, in document EP 1 041 696 for example. In this document, the flanging tool has means to maintain circumferentially the ends of the conductive segment pairs to be welded and means to maintain radially the ends of each pair of conductive segments to be welded, as well as a device to weld the end of each pair of conductive segments maintained circumferentially and radially.

This flanging tool is shaped to act on two pairs of conductive segments in the form of pins. Each pair belongs to a circumferential weld row.

The radial maintenance means include an internal tool that is large and bulky.

3. Purpose of the Invention

Therefore, the purpose of the invention is to propose a welding arrangement in which the flanging tool is less complex and less bulky in comparison with the current state of the technology.

To achieve this purpose, the welding arrangement according to the invention is characterized by the fact that the circumferential locking means are formed by cam-shaped sections that are part of the flanging members and by the fact that a cam-shaped section is configured so that it enters a clamped position between radial rows of circumferentially adjacent ends of conductive segment pairs to be welded, by rotating the flanging element.

In other words, a flanging element has a transversal section in the form of a cam that is configured to ensure locking by rotation when it is in place between two rows of circumferentially adjacent ends of conductive segment pairs to be welded.

With the invention, each radial row may contain one or more pairs of conductive segment ends to be welded.

Advantageously, the flanging tool consists of one rod.

According to one characteristic of the invention, a cam section has an oval transversal section the thickness of which, in the direction of the large axis, is generally equal to the distance between the two circumferentially adjacent radial rows between which it might engage, while the thickness in the perpendicular direction of the small axis is less than the thickness. The insertion and extraction of the cam section between two radial rows is, therefore, performed simply and quickly.

The insertion and extraction of the cam section is performed by radial displacement of this section, in relation to the support body, in the groove delimited by two circumferentially adjacent radial rows, i.e. rows that are consecutive along the circumference.

In addition, the conductive segments are arranged to prevent damaging the segments.

As a variant, this movement is performed by axial displacement of the cam section in relation to the body in order to move in or out of the groove.

According to another characteristic of the invention, the circumferential locking cam section has at least two teeth that project from the cam surface in the direction of the circumferential locking thickness, and the cam has a space that ensures, during the rotation of the cam in its circumferential locking position, tight clamping of a pair of conductive segment ends to be welded between the two teeth.

According to another characteristic of the invention for a winding that has two pairs of conductive segment ends to be welded, in each radial row, with an interval between the two pairs, the cam-shaped portion has three teeth separated from each other by the aforementioned clamping distance between them for a pair of conductive segment ends to be welded, with the central tooth fitting in the interval formed between the two end pairs.

According to another characteristic of the invention, the front surfaces in the direction of rotation of the teeth are chamfered so that the conductive segment ends engage between the teeth. In this way, good radial clamping of the conductive segment ends to be welded is achieved.

According to another characteristic of the invention, the means of radial locking have two elements that are advantageously in the form of rings to maintain the pairs of conductive segment ends to be welded between them, in the radial direction.

Thus, the radial locking means are strong and there are fewer of them.

According to another characteristic of the invention for a winding with two pairs of conductive segment ends to be welded in a radial row, the radial flanging means also have a ring gear intended to fit into the interval formed between the two end pairs of the rows to ensure the radial locking in cooperation with the aforementioned rings.

This ring gear is also strong and allows the number of parts to be reduced.

According to another characteristics! of the invention, the part of the central ring gear designed to fit into the interval between the two row end pairs to be welded has a tapered profile.

This profile allows good radial clamping of the two pairs of conductive segments to be welded.

It can be seen that, thanks to the teeth of the rod or to the ring gear, the distance between two radially adjacent pairs of conductive segment ends to be welded is guaranteed.

According to another characteristic of the invention, the cam portion has a centering groove intended to receive the front part of the tapered section of the central ring gear.

According to another characteristic of the invention, the arrangement includes a device to expel slag resulting from the welding operation outside the stator by blowing air jets below the welds.

According to another characteristic of the invention, the blowing device has a suction slot for the air jets loaded with the expelled slag.

According to another characteristic of the invention, the welding device is the laser beam type.

### BRIEF DESCRIPTION OF DRAWINGS

The invention will be better understood, and other purposes, characteristics, details and advantages of the invention will appear more clearly during the explanatory description that follows, which refers to the attached drawings provided only as examples illustrating two methods for fabricating the invention, in which:

FIG. 1 is a perspective view of a portion of a winding of a rotating electrical machine stator equipped with a flanging tool according to the invention, shown schematically;

The notches of the sheets are aligned to form multiple notches that cross the body 1 from side to side. Here, the notches are aligned to form multiple axial grooves 7.

The notches are advantageously the semi-closed type and open into the central opening of the body 1. For more details, refer, for example to document EP A 0 961 386.

Thus, in one form of fabrication, an insulator is mounted in each notch to isolate the conductive segments 5 of the body 1 of the stator.

These insulators may each have an overlapped section away from the opening of the notch in which the insulator is mounted; said opening exits at the internal periphery of the body of the stator that is generally tube-shaped

The rotating machine is, for example, a multiphased alternator for an automobile as described in the aforementioned document EP A 0 961 386.

In this case, the central opening of the body 1 serves as the housing for the alternator rotor, such as a rotor with clamps or, in a variant, a rotor with projecting poles which may be equipped with permanent magnets alternating around the circumference with the projecting poles. The body 1 is then supported on the external periphery by a support in the form of a crankcase that has, for example, two parts called the front bearing and the rear bearing. These bearings are configured to each centrally support one ball bearing for the rotation mounting of a shaft integrated with the rotor that has, at its front end on the front bearing side, a drive pulley designed to be connected by at least one belt to the crankshaft of the vehicle motor and, at the rear end on the rear bearing side, slip rings.

The alternator is, for example, triphased. As a variant, the alternator has more than three phases.

In one variant, this alternator is the reversible type and also operates in electric motor mode to start the thermal motor of the automobile. Such an alternator is called an alternator-starter.

As is known, each phase has an input and an output connected by conductive segments 5. The phase outputs and/or inputs are connected to a device to convert the alternating current produced in the stator into direct current; this device is most often supported by the rear bearing.

The conductive segments 5 are arranged, in the case shown, in a group of four in the axial notches 7 of the stator body stator 1 and form in this case, at the level of the second chignon 3, two circumferential rows of radially aligned ends, with one end pair per row. Thus, a row of four conductors is formed radially. The conductors 5 are juxtaposed by layer in the radial direction inside these notches. The end of the conductive segment pairs are juxtaposed in a radial direction of the support body and circumferentially offset from each other on the outside of the body 1. Thus, on the outside of the body 1, at the level of the chignon 3, radially rows are formed that are circumferentially offset and have at least one pair of conductive segments to be welded.

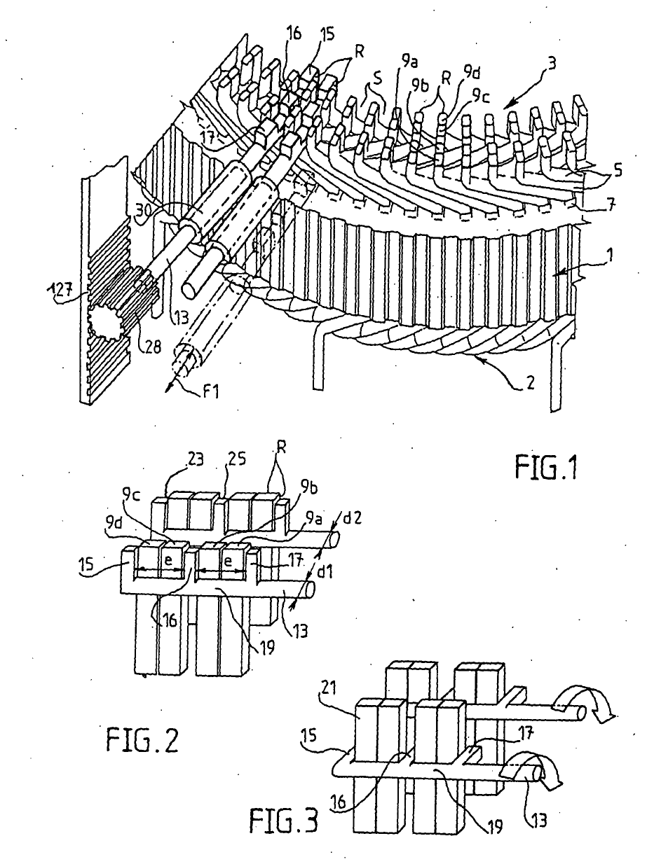

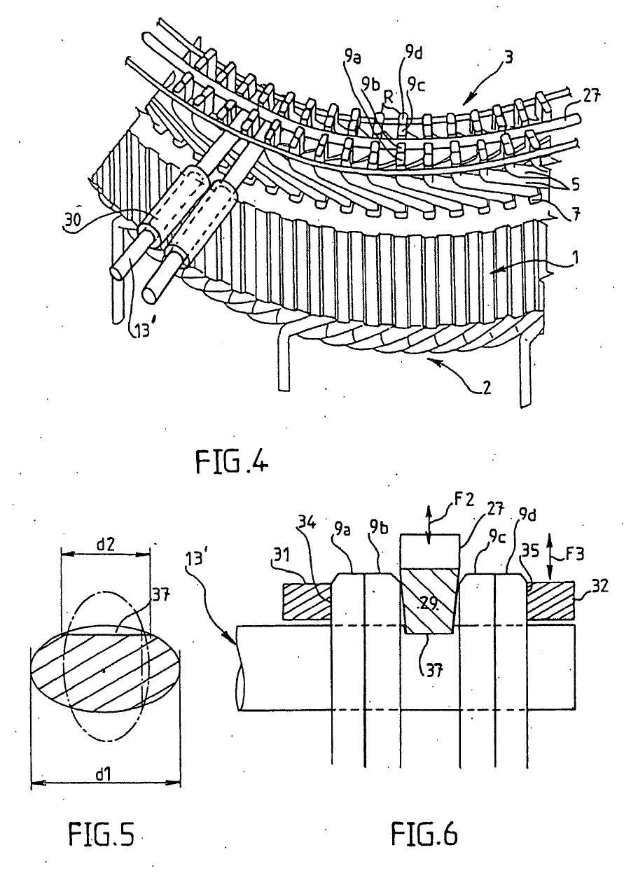

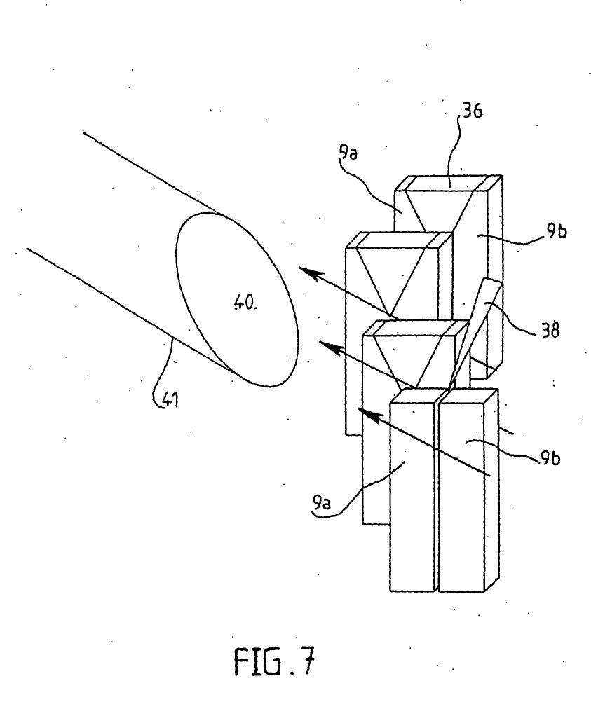

In FIG. 1, two pairs of radially aligned conductive segments ends are installed for each radial row. This number depends on the application. After welding, two concentric annular rows of welds are formed.

Here, the section of the conductors are rectangular in shape, and the lengths are parallel to the lateral edges of the notches as shown on FIG. 8 of the aforementioned document EP A 0 961 386.

These conductors belong to the branches of pins in the form of a U. The branches of the pins are mounted in notches separated from each other by a pole pitch and occupy different layers in the notches in question

The phase inputs and outputs are advantageously located at the level of the heads of the pins projecting at one of the axial ends of the body of the stator 1 to form the first 2. In FIG. 1, some of these inputs and outputs (not marked) are shown.

The branches of the pins cross the body 1 toward the notches 7 to form by projection, at the other axial end of the body of the stator, the second chignon 3 in the form of a ring.

The free ends of the pins are welded to be connected in series at the level of the second chignon 3, which is ring-shaped, and advantageously extend at the same height as described in WO 92/06257.

In referring to this document, we see that, in the first step, the heads of the pins are twisted using a first mounting device. Then, in a second step, we insert the branches of the pins into the notches 7 of the body 1 of the stator, and then we twist the free ends of the branches using a second mounting device.

Thus, FIG. 1 shows the winding after the twisting of the free ends of the conductive segments which are initially formed by pins in a U shape. As in document EP A 0 961 386, in chignon 3, four conductive segment ends are arranged in a radial row R. The four ends designated by references 9a to 9d are radially grouped in pairs 9a, 9b and 9c, 9d. The ends 9a, 9b and 9c, 9d of each pair must be connected by welding. Although the pins 5 are covered with an electrically insulating enamel layer, it is not crucial to strip the ends to be connected by welding, because the welding here is a laser-type welding. More specifically in this case, the welding is controlled sequentially, and the laser beam is interrupted between two welding operations. During the welding the laser beam is fixed in relation to the body 1, equipped with the free ends of the conductive segments to be welded. For more details, refer to document WO 02/069472.

Given that the welding operation requires precise positioning of the conductors in relation to the energy source (not shown), it is known through document EP A 1 041 696 cited above to provide a flanging tool, the function of which is to ensure electric contact between the conductors to be welded and a precise radial and angular or circumferential positioning of the ends to be welded. To achieve this, the flanging tool has radial maintenance means and means for circumferential locking of the conductive segment ends to be welded.

The invention proposes a tool for flanging the ends of the conductors to be welded; this tool has a very simple structure and is small in size.

More specifically, the flanging tool according to the invention has circumferential locking means that are formed, as described below, by cam-shaped sections 19 of multiple flanging members 13, two of which are shown in the figures.

A flanging member 13 has the shape of a rod.

In one fabrication method, the rod is configured to have the form of a key that has at least two teeth to flange a pair of conductive segments to be welded.

In the fabrication method of FIGS. 1 to 3, the rod has a flanging end of the conductive pairs which is configured to have the form of a key containing three teeth 15, 16, 17, which are regularly spaced axially. The axial space between two adjacent teeth 15, 16 and 16, 17 corresponds to the width in the radial direction of the two ends 9a, 9b or 9c, 9d of the two pairs of conductive segments, as can be clearly seen on FIG. 3, while the width of the central tooth 16 corresponds to the interval 25 between the two pairs of ends to be welded. The three teeth guarantee the distance between two pairs, radially aligned along a row R, of free ends of conductive segments to be welded.

According to one characteristic of the invention, each flanging rod 13 can be moved axially between a neutral position shown in chain dotted lines on FIG. 1, in which the flanging key portion is outside the groove S delimited between two rows R, which are circumferentially adjacent or consecutive, of conductive segment ends 9a to 9d, and a position inside the groove S as shown for the two flanging rods 13 shown with solid lines. The movement of the flanging members is shown by the double arrow F. This movement is radial in the direction of the axis of the corresponding groove S.

In a variant, the neutral position can also be obtained by axial displacement of the keys in relation to the body 1 for the insertion of the keys into the grooves S. The rods, which are positioning elements, can be made to turn around their axis in a 90° angle when they occupy their final position inside their groove S. FIGS. 2 and 3 show the two flanging members 13 in their position before and after rotation of the rods. As these figures show, in the turned position in FIG. 3, the two end pairs 9a, 9b and 9c, 9b of each pair are trapped between the teeth 17 and 16, and between 16 and 15, and the tooth 16 is engaged in the interval 25 between the two end pairs to be welded. Thus, the teeth constitute means to maintain and radially lock the ends to be welded 9a to 9d.

In addition to locking the conductive pairs in the radial direction with teeth 15, 16, 17, the flanging members 13 also permit locking in the circumferential direction. For this purpose, according to one characteristic of the invention, the segments 19 of the rods 13 between two adjacent teeth have a cam-shaped transversal section, which is advantageously oval, as can be seen in FIG. 5. In its segments 19, the rod has, in the direction of the teeth 15 to 17, a thickness d1 that corresponds to the distance in the circumferential direction of two adjacent rows R of conductive segment ends 9a to 9d, i.e., to the width S of the groove delimited between its two rows. More specifically, the thickness d1 is chosen so that the flanging members 13, in their position for radial locking of the end pairs to be welded, shown in FIG. 3, come in contact and are pressed against the lateral surfaces 21 of the two rows R between which they are engage, thus also providing circumferential locking of the conductive pairs to be welded.

In contrast, the cam-shaped segments 19 of the flanging members 13 present, perpendicularly to the thickness d1, a smaller thickness d2, which allows the easy insertion of the key-shaped segments of the members 13 into the grooves S in the position shown in FIGS. 1 and 2.

It should also be noted that the teeth 15 to 17 are chamfered on the front surface 23 to ensure easy insertion of the key segment of the flanging members 13 into the space 25 between the two conductive pairs 9a, 9b and 9c and 9d of a row R.

With respect to the device to displace the flanging members 13 between their neutral position and their locking position, any known device can be used, provided that it ensures a radial back-and-forth movement of these members or an axial back-and-forth movement of these members inside the grooves with width S and a rotation in a 90° angle when they occupy their axial end-of-travel position between the ends of the conductors inside the chignon 3. FIG. 1 shows, only as a non-limiting example, one possibility for using the flanging member control device. In this example, rotation is ensured by a device of the rack 127 and pinion 28 type, with the pinion integrated in rotation with the rod of the flanging member, and the rod and members are supported and axially guided in bearings 30 which must be designed to belong to a fixed support structure.

Concerning the operation of the flanging tool, the radial and circumferential locking of the conductive ends to be welded is achieved by simultaneous insertion and rotation of the flanging members 13.

FIGS. 4 to 6 illustrate a second method for fabricating the flanging tool according to the invention. According to this fabrication method, the tool has multiple rods 13′ that are displaced axially between a neutral position outside the chignon 3 and a locking position inside the chignon, as in the case of the first fabrication method. The front locking part of the rods is cam-shaped, advantageously oval, according to FIG. 5, with thicknesses d1, d2 in the same way and for the reasons described above for the first fabrication method. In contrast with the first method, the locking portion does not have teeth and locks only in the circumferential direction.

Radial locking is achieved by locking members 31, 32 and a central ring shown as 27 on FIGS. 4 and 6, which is nearly coaxial to the axis of the stator and can be moved in translation in the manner shown by the double arrow F2 on FIG. 6 between a position on top of the chignon (not shown) and the position shown, in which the ring is engaged in space 25 between the two pairs of conductive ends to be welded in a row R.

For this purpose, the lower section 29 of the ring 27, which fits into space 25, has a tapered profile. The tapered profile thus ensures the radial locking effect in the manner shown in FIG. 6, in cooperation with two locking members 31, 32, which are advantageous in the form of coaxial rings 31, 32 that can be moved in the direction of the arrows F3 between a position above the chignon 3 (now shown) and a radial locking position in which the rings 31, 32 act as supports, with ring 31 against the radially exterior lateral surface 34 of the conductor end 9a and ring 32 against the radially interior lateral surface 35 of the conductive end 9d in each row R.

It should again be noted that the locking cam parts of the flanging members 13′ present, on the peripheral surface, a centering notch 37 for the tapered section 29 of the ring 27 in its locking position illustrated in FIG. 6. Therefore, notch 37 is made in the low curve section, as we see in FIG. 5.

Concerning the axial displacement and rotation means of the flanging members 13′, any appropriate device known can be used such as, for example, the principle of the rack and pinion type shown in FIG. 1 for the flanging members 13. For the movements of the central locking ring 27 and the lateral locking rings 31, 32, since these are simple translation movements, it is not necessary to describe specifically the devices to implement these displacements. It is clear that traditional means can be used for this purpose.

It should be noted that the oval shape, an ellipse for example, without a flat surface, of the locking cam sections of the flanging members has proven very advantageous, since one avoids damaging the conductive segments during the rotation of the cam-shaped section or sections.

In addition to the flanging tool, the invention proposes a blowing device for the parts located beneath the welds. This device expels the slag resulting from the welding operation out of the stator and a suction device recovers the slag and thus prevents any pollution of the environment. FIG. 7 shows schematically such a blowing device.

This figure shows the ends of three pairs of pin conductors after the welding operation; the weld is shown at 36. A fourth pair of pins is in the process of being welded by a laser beam designated by reference 38. The figure shows air jets J, in the form of arrows, which are produced by a blowing source that is not shown, and which are directed to pass beneath the welds. The air jets that expel the slag from the welding operation outside the stator chignon are then vacuumed up by a suction slot 40 of a suction tube 41.

In this way, the invention ensures the disassociation of the stator maintenance and protection operations during the welding operation performed with a laser beam. Thus, protection of the stator is provided by an independent device of the flanging tool whereas, in the current state of the technology, the stator is protected by the flanging system which is also used for the heat flows in order to limit the deterioration of the coating enamel of the winding conductors.

Thus, the invention allows welding of non-stripped conductors, while protecting the stator against ashes from burned enamel.

Of course, this invention is not limited to the fabrication examples described.

Thus, it may have only one circumferential row of welding to be performed. In this case, a single pair of conductive segments 5 is mounted in the notches 7; this pair has the free ends 9d, 9c to be welded at the level of the chignon 3.

In this case, the key has only two teeth, i.e. teeth 15 and 16 or, in a variant, only the ring 32 and slip ring 27.

In a variant, the number of pairs of conductive segments in the notches is greater than two. In this case, the number of teeth in the key or the number of slip rings must be increased.

For example, for three pairs of ends to be welded, four teeth must be provided.

Of course, the notches of the body 1 may be the open type, being closed by slot wedges, or they may be closed type as described in document U.S. Pat. No. 1,826,295. In light of this document, we see that the body 1 is, in a variant, the body of a rotor. Thus, the rotating electrical machine may be, in a variant, a dynamo or an electric motor, such as the electric motor of a starter. In a variant, the electrical machine belongs to an electromagnetic retarder of the type, for example, described in document EP A 0 331 559, with its rotor equipped with a winding of the same type as in FIG. 1.

As shown by the description and the drawings, there are multiple rods 13, 13′ to reduce wear. In effect, each of the rods is inserted in a groove delimited by two circumferentially adjacent radial rows, and flanging is performed by rotation as described above. Then, the welding is performed row by row sequentially using a laser beam. The laser bursts are executed for 0.05 to 0.06 seconds, for example, to weld a row. Then, the body 1 equipped with the rods 13, 13′ is turned to move to the following row; the laser is off between each weld.

Thus, the rods are handled only two times (closing and opening) to weld all the ends to be welded. As a variant, one or more rods are used, but these must be handled after one or more welds, which increases the wear and the total welding time.

Of course, thanks to the thickness d2, the rods can be inserted in the grooves despite the radial variation (small in this case) in the width S.

In a variant, the thickness d1 can vary to take this variation into account.

Any other type of welding may be considered.

In a variant, the pins are in two parts welded at the level of the pin heads as described in the aforementioned document EP A 0 961 386.

In this case, welding is also performed at the level of the first chignon using a flanging tool similar to the tool in FIGS. 1 to 6.

1. An arrangement for welding the ends of electrically conductive segment pairs, called conductive segments, of a winding of a rotating electrical machine formed by multiple conductive segments mounted in series and supported by a support body (1) so that the ends of each pair of conductive segments to be welded form, on an axial side of the support body (1), a chignon (3) in the form of a slip ring, in which the ends of the pairs of conductive segments to be welded are juxtaposed in a radial direction to the support body and are arranged on the outside of the support body (1) in the form of radial rows (R) that are offset circumferentially from each other; said welding arrangement has a flanging tool for the ends of the conductive segments to be welded, and this tool has means for the circumferential locking of these ends to be welded in their welding position, characterized by the fact that the circumferential locking means are formed by cam-shaped sections (19) of flanging members (13, 13′) and by the fact that a cam section (19) is configured so that it is in clamped position between the ends of the two circumferentially adjacent radial rows (R) of conductive segments to be welded by rotating the flanging member.

2. The arrangement according to claim 1, characterized in that the flanging members (13, 13′) move between a neutral position outside the chignon (3) and an active position between the conductive segment pairs (9a, 9b; 9c, 9d) of said two circumferentially adjacent radial rows (R).

3. The arrangement according to claim 2, characterized in that the cam section (19) has an oval transversal section with, in the direction of its large axis, a thickness (d1) that is nearly equal to the distance between said two circumferentially adjacent rows (R), between which it may engage, while the thickness in the perpendicular direction of the small axis is less than the thickness (d1).

4. The arrangement according to claim 3, characterized in that the circumferential locking came has at least two teeth (15, 16) which project from the cam surface in the direction of the circumferential locking thickness (d1) and has a spacing (e) that ensures, during the rotation of the cam in its circumferential locking position, the clamped fit between the two teeth (15, 16) of a pair of conductive segment ends to be welded.

5. The arrangement according to claim 4, for a winding that has, in each radial row, two pairs (9a, 9b; 9c, 9d) of segment ends to be welded, with an interval (25) between the two pairs, characterized by the fact that the cam-shaped section (19) has three teeth (15, 16, 17) separated from each other by the aforementioned distance (e) for the clamped insertion between them of a pair of ends to be welded; the central tooth (16) fits into the interval (25) formed between the two pairs of ends.

6. The arrangement according to claim 5, characterized in that the front surfaces in the direction of rotation of the teeth (15, 16, 17) are chamfered to allow the conductive segment ends to engage between the teeth.

7. The arrangement according to claim 1, characterized in that the radial locking means have two members (31, 32) for maintaining between them, in the radial direction, the pairs of conductive segment ends to be welded.

8. The arrangement according to claim 7 for a winding with two pairs of conductive segment ends to be welded in a radial row (R), characterized by the fact that the radial flanging means also have a slip ring (27) designed to fit in the interval (25) formed between the two end pairs (9A, 9B; 9C, 9D) of the rows (R) to ensure radial locking in cooperation with the aforementioned rings (31, 32).

9. The arrangement according to claim 8, characterized in that the part of the central slip ring (27), which is intended to fit into the interval (25) between the two pairs of conductive segment ends to be welded in the rows (R) has a tapered profile.

10. The arrangement according to one of the claims 7 or 8, characterized in that the central slip ring has a tapered portion, and that the cam section (19) has a centering groove (37) intended to receive the front part of the tapered section (29) of the central slip ring (27).

11. The arrangement according to claim 1, characterized in that it includes a device to expel slag from the welding operation outside the stator by blowing air jets (J) beneath the welds.

12. The arrangement according to claim 11, characterized in that the blowing device has a suction slot (40) with air jets loaded with the slag that has been removed.

13. The arrangement according to claim 1, characterized in that the welding device is the laser beam type.
